(19) United States
(12) Patent Application Publication
(10) Pub. No.: US 2023/0011823 A1
(43) Pub. Date: Jan. 12, 2023

(54) METHOD FOR CONVERTING IMAGE FORMAT, DEVICE, AND STORAGE MEDIUM

(71) Applicant: Beijing Baidu Netcom Science Technology Co., Ltd, Beijing (CN)

(72) Inventors: Qi ZHANG, Beijing (CN); Weidong Hu, Beijing (CN)

(21) Appl. No.: 17/939,401

(22) Filed: Sep. 7, 2022

Related U.S. Application Data
(63) Continuation of application No. PCT/CN2022/075034, filed on Jan. 29, 2022.

(30) Foreign Application Priority Data
Apr. 7, 2021 (CN) 202110372421.7

(51) Int. Cl. G06T 5/00; G06V 10/42; G06V 10/44; G06V 10/80

(52) U.S. Cl. CPC G06T 5/007; G06V 10/42; G06V 10/44; G06V 10/806; G06T 2207/20208

(57) ABSTRACT

The present disclosure provides a method and apparatus for converting an image format, an electronic device, a computer readable storage medium and a computer program product, relates to the field of artificial intelligence technology such as computer vision and deep learning, and can be applied to intelligent sensing ultra-definition scenarios. A specific implementation of the method includes: acquiring a to-be-converted standard dynamic range image; performing a convolution operation on the standard dynamic range image to obtain a local feature; performing a global average pooling operation on the standard dynamic range image to obtain a global feature; and converting the standard dynamic range image into a high dynamic range image according to the local feature and the global feature.

### CROSS-REFERENCE TO RELATED APPLICATION

This patent application is a U.S. continuation of international application serial No. PCT/CN2022/075034 filed on Jan. 29, 2022, which claims the priority of Chinese Patent Application No. 202110372421.7 filed on Apr. 7, 2021 and entitled “METHOD AND APPARATUS FOR CONVERTING IMAGE FORMAT, DEVICE, STORAGE MEDIUM AND PROGRAM PRODUCT”, the entire disclosures of which are hereby incorporated by reference.

### TECHNICAL FIELD

The present disclosure relates to the field of artificial intelligence, specifically to the fields of computer vision and deep learning technologies, and particularly to a method for converting an image format, an electronic device, and a computer readable storage medium, and can be applied to intelligent sensing ultra-definition scenarios.

### BACKGROUND

With the increasing pursuit of better quality of life, the general public has higher and higher requirements for the quality of media contents they watch daily. The synchronous development of hardware devices has brought high-definition and even 4K videos to millions of people.

However, at present, the vast majority of media contents are still only supported in an SDR (standard dynamic range) format. Compared with the SDR format, an HDR (high dynamic range) format has increased the number of its data storage bits from 8 bit to 10 bit, and has converted its color space from BT709 to BT2020. The improvement in parameters leads to a huge and shocking improvement in visual perception.

The existing technologies provide the following schemes of converting images from the SDR format to the HDR format: a scheme of reconstructing an HDR image based on a plurality of frames of SDR images with different exposure times, a scheme of reconstructing an HDR image based on an SDR image of a camera response curve, and a scheme of reconstructing an HDR image based on an SDR image of image decomposition.

### SUMMARY

Embodiments of the present disclosure provide a method for converting an image format, an electronic device, and a computer readable storage medium.

According to a first aspect, embodiments of the present disclosure provide a method for converting an image format, which includes: acquiring a to-be-converted standard dynamic range image; performing a convolution operation on the standard dynamic range image to obtain a local feature; performing a global average pooling operation on the standard dynamic range image to obtain a global feature; and converting the standard dynamic range image into a high dynamic range image according to the local feature and the global feature.

According to a second aspect, embodiments of the present disclosure provide an electronic device, which includes: at least one processor; and a storage device, in communication with the at least one processor, where the storage device stores instructions executable by the at least one processor, and the instructions, when executed by the at least one processor, cause the at least one processor to perform the method for converting an image format as described in any implementations of the first aspect.

According to a third aspect, embodiments of the present disclosure provide a non-transitory computer readable storage medium storing computer instructions, where the computer instructions cause the computer to perform the method for converting an image format as described in any implementations of the first aspect.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

Through the detailed description of non-limiting embodiments given with reference to the following accompany drawings, other features, objectives and advantages of the present disclosure will become more apparent:

FIG. 1 illustrates an exemplary system architecture in which the present disclosure may be applied;

FIG. 2 is a flowchart of a method for converting an image format provided by an embodiment of the present disclosure;

FIG. 3 is a flowchart of another method for converting an image format provided by an embodiment of the present disclosure;

FIG. 4 is schematic flow diagram of a model converting a standard dynamic range image into a high dynamic range image, provided by an embodiment of the present disclosure;

FIG. 5 a schematic structural diagram of a GL-GConv Resblock provided by an embodiment of the present disclosure;

FIG. 6 a schematic structural diagram of an SEBlock provided by an embodiment of the present disclosure;

FIG. 7 is a structure block diagram of an apparatus for converting an image format provided by an embodiment of the present disclosure; and

FIG. 8 is a schematic structural diagram of an electronic device provided by an embodiment of the present disclosure and adapted to perform the method for converting an image format.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions of well-known functions and structures are omitted in the following description. It should be noted that the embodiments in the present disclosure and the features in the embodiments may be combined with each other on a non-conflict basis.

In the technical solution of the present disclosure, the acquisition, storage, application, etc. of the user personal information all comply with the provisions of the relevant laws and regulations, necessary confidentiality measures are taken, and public order and good customs are not violated.

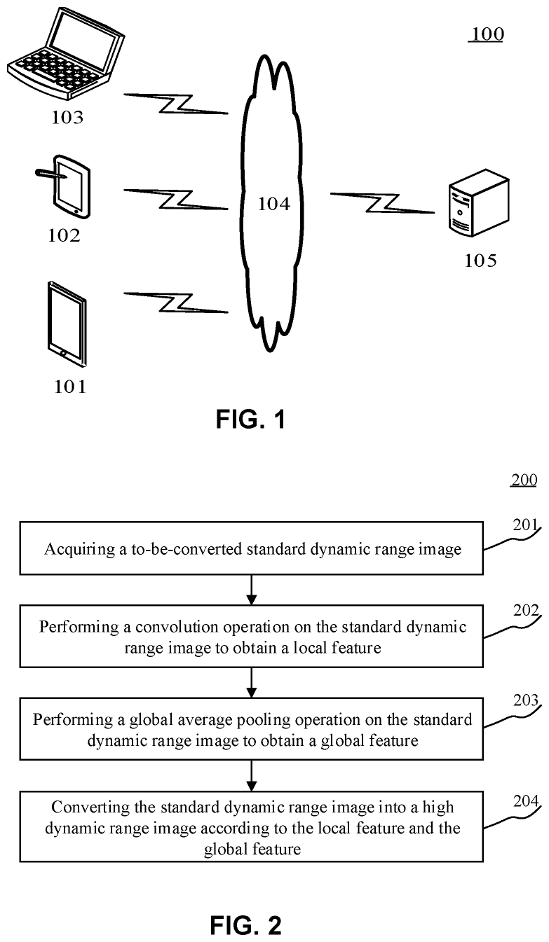

FIG. 1 illustrates an exemplary system architecture 100 in which embodiments of a method and apparatus for converting an image format, an electronic device and a computer readable storage medium according to the present disclosure may be applied.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as, wired or wireless communication links, or optical fiber cables.

A user may use the terminal devices 101, 102 and 103 to interact with the server 105 via the network 104 to receive or send messages, etc. On the terminal devices 101, 102 and 103 and the server 105, various applications (e.g., a video-on-demand application, an image/video format conversion application, and an instant communication application) for implementing information communications between the terminal devices 101, 102 and 103 and the server 105 may be installed.

The terminal devices 101, 102 and 103 and the server 105 may be hardware or software. When being the hardware, the terminal devices 101, 102 and 103 may be various electronic devices having a display screen (including, but not limited to, a smart phone, a tablet computer, a laptop portable computer, and a desktop computer), as well as projection devices that can also be used to display images and display devices including a display. When being the software, the terminal devices 101, 102 and 103 may be installed on the listed electronic devices. The terminal devices 101, 102 and 103 may be implemented as a plurality of pieces of software or a plurality of software modules, or as a single piece of software or a single software module, which will not be specifically limited here. When being the hardware, the server 105 may be implemented as a distributed server cluster composed of a plurality of servers, or may be implemented as a single server. When being the software, the server may be implemented as a plurality of pieces of software or a plurality of software modules, or may be implemented as a single piece of software or a single software module, which will not be specifically limited here.

The server 105 can provide various services through various built-in applications. Taking an image format conversion application capable of converting standard dynamic range images into high dynamic range images in batches as an example, the server 105 can achieve the following effects when running the image format conversion application. First, a to-be-converted standard dynamic range image is acquired from the terminal devices 101, 102 and 103 via the network 104. Then, a convolution operation is performed on the standard dynamic range image to obtain a local feature. Next, a global average pooling operation is performed on the standard dynamic range image to obtain a global feature. Finally, the standard dynamic range image is converted into a high dynamic range image according to the local feature and the global feature.

It should be pointed out that, in addition to being acquired from the terminal devices 101, 102 and 103 via the network 104, the to-be-converted standard dynamic range image can be pre-stored locally in the server 105 in various ways. Therefore, when detecting that this data has been stored locally (e.g., a previously retained to-be-processed image format conversion task before the processing starts), the server 105 can choose to directly acquire this data locally. In such a case, the exemplary system architecture 100 may not include the terminal devices 101, 102 and 103 and the network 104.

Since the conversion from the standard dynamic range image to the high dynamic range image requires many computing resources and a strong computing capability, the method for converting an image format provided in the subsequent embodiments of the present disclosure is generally performed by the server 105 having a strong computing capability and many computing resources, and correspondingly, the apparatus for converting an image format is generally provided in the server 105. However, meanwhile, it should be pointed out that, when the terminal devices 101, 102 and 103 also have a computing capability and computing resources that meet the requirements, the terminal devices 101, 102 and 103 can also, through the image format conversion application installed on the terminal devices 101, 102 and 103, complete the above computations that should have been completed by the server 105, thus outputting the same result as the server 105. Particularly, when there are many terminal devices with different computing capabilities at the same time, but the image format conversion application determines that the terminal device on which the application is installed has a strong computing capability and many remaining computing resources, it is possible to make the terminal device perform the above computations, which appropriately reduces the computation stress of the server 105. Correspondingly, the apparatus for converting an image format may alternatively be provided in the terminal devices 101, 102 and 103. In such a case, the exemplary system architecture 100 may not include the server 105 and the network 104.

It should be appreciated that the numbers of the terminal devices, the network, and the server in FIG. 1 are merely illustrative. Any number of terminal devices, networks, and servers may be provided based on actual requirements.

According to the method for converting an image format, the electronic device, and the computer readable storage medium that are provided in the embodiments of the present disclosure, the to-be-converted standard dynamic range image is first acquired; then, the convolution operation is performed on the standard dynamic range image to obtain the local feature; next, the global average pooling operation is performed on the standard dynamic range image to obtain the global feature; and finally, the standard dynamic range image is converted into the high dynamic range image according to the local feature and the global feature.

Different from the schemas of converting a standard dynamic range image into a high dynamic range image in the existing technologies, in the present disclosure, a convolutional layer is used to extract the local feature of the standard dynamic range image, and a global average pooling layer is used to extract the global feature of the standard dynamic range image. Since the global feature of the standard dynamic range image is directly extracted through an independent global average pooling layer, a more accurate global feature can be extracted, and then the details required by the high dynamic range image can be obtained based on a more accurate supplement, thereby improving the quality of the converted high dynamic range image.

Referring to FIG. 2, FIG. 2 is a flowchart of a method for converting an image format provided by an embodiment of the present disclosure. Here, a flow 200 includes the following steps:

Step 201, acquiring a to-be-converted standard dynamic range image.

This step is intended to acquire, by an execution body (e.g., the server 105 shown in FIG. 1) of the method for converting an image format, the to-be-converted standard dynamic range image, i.e., an SDR image of which the format is to be converted. Specifically, the SDR image may be obtained from an SDR video by a frame extraction technique, or may be independently and directly generated according to an SDR format.

Step 202, performing a convolution operation on the standard dynamic range image to obtain a local feature.

Based on step 201, this step is intended to extract, by the above execution body, the local feature from the standard dynamic range image. The local feature is obtained by performing the convolution operation on the standard dynamic range image.

Here, a convolution generally has a convolution kernel of a fixed size, such as, 3×3. Taking a convolution kernel of 1×1 as an example, the convolution operation is equivalent to performing a convolution on the image features of 9 pixel points each time, thus “concentrating” them into one pixel point. Therefore, the convolution operation is also generally referred to as down-sampling. Also, the convolution operation is characterized in that the convolution is only for local features, and thus, in this step in the present disclosure, the convolution operation is performed to extract the local feature. Specifically, in order to improve the accuracy of the extracted local feature as much as possible, the number of convolution operations may be more than one, and a convolution kernel of a different size may be used each time.

Step 203, performing a global average pooling operation on the standard dynamic range image to obtain a global feature.

Based on step 201, this step is intended to extract, by the above execution body, the global feature from the standard dynamic range image. The global feature is obtained by performing the global average pooling operation on the standard dynamic range image.

Global average pooling is a concept that appears in a machine learning algorithm. The general operation of the global average pooling is to add all pixel values of a feature map together and then average them, thus obtaining a numerical value. That is, the numerical value is used to represent a corresponding feature map, that is, the numerical value is obtained by synthesizing all the pixels of the entire feature map. Therefore, the global feature can be reflected as much as possible.

It should be noted that there is no causal and dependent relationship between the acquisition operation of the local feature provided in step 202 and the acquisition operation of the global feature provided in step 203, and the acquisition operations can be performed simultaneously or independently. The flowchart shown in FIG. 2 is expressed using a simple serial execution approach, and does not mean that step 203 must be performed only after step 202 is completed.

In addition, if the conversion environment is in an image conversion model constructed based on machine learning, the above step 202 may specifically refer to: extracting the local feature of the standard dynamic range image using a convolutional layer of a preset image format conversion model, the convolutional layer including at least one convolution operation. Step 203 may specifically refer to: extracting the global feature of the standard dynamic range image using a global average pooling layer of the preset image format conversion model, the global average pooling layer including at least one global average pooling operation.

Step 204, converting the standard dynamic range image into a high dynamic range image according to the local feature and the global feature.

Based on step 202 and step 203, this step is intended to comprehensively supplement, by the above execution body, the missing image details of the standard dynamic range image with respect to the high dynamic range image according to the extracted local feature and the extracted global feature, such that the quality of the converted high dynamic range image is better.

Different from the schemas of converting a standard dynamic range image into a high dynamic range image in the existing technologies, the present disclosure provides a method for converting an image format. According to the method, the convolutional layer is used to extract the local feature of the standard dynamic range image, and the global average pooling layer is used to extract the global feature of the standard dynamic range image. Since the global feature of the standard dynamic range image is directly extracted through an independent global average pooling layer, a more accurate global feature can be extracted, and then the details required by the high dynamic range image can be obtained based on a more accurate supplement, thereby improving the quality of the converted high dynamic range image.

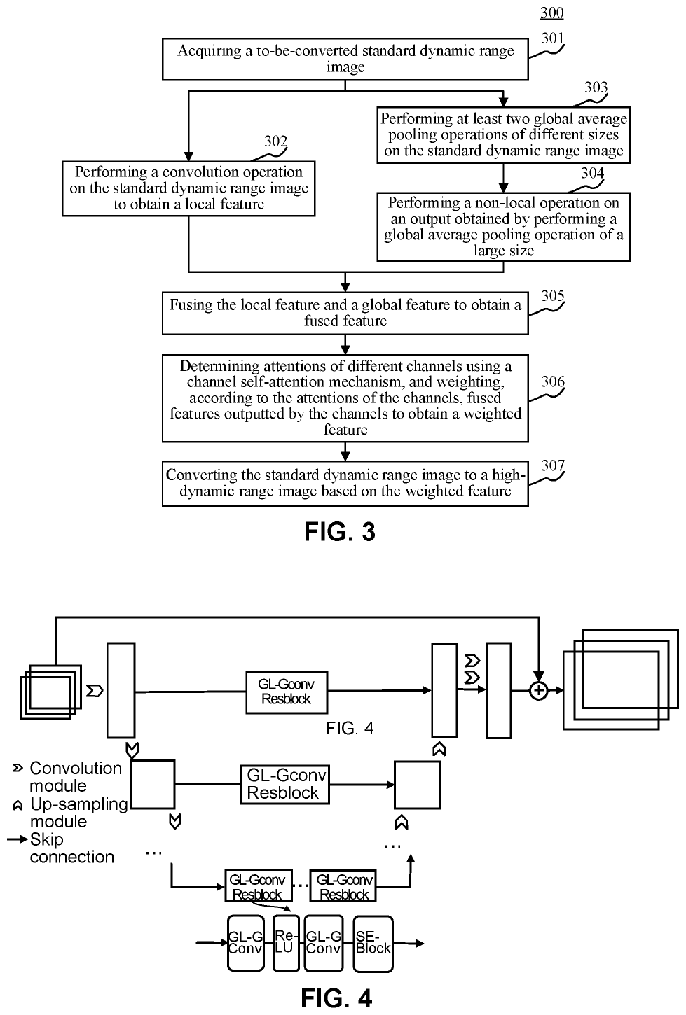

Referring to FIG. 3, FIG. 3 is a flowchart of another method for converting an image format provided by an embodiment of the present disclosure. Here, a flow 300 includes the following steps:

Step 301, acquiring a to-be-converted standard dynamic range image.

Step 302, performing a convolution operation on the standard dynamic range image to obtain a local feature.

Step 303, performing at least two global average pooling operations of different sizes on the standard dynamic range image.

On the basis of the previous embodiment, in order to improve the effectiveness of the extracted global feature as much as possible, this embodiment further provides the at least two global average pooling operations of the different sizes performed on the standard dynamic range image. Taking two sizes as an example, the pixel features of the entire feature map are finally represented as a matrix [1,1] after the global pooling operation of a first size is performed, and the pixel features of the entire feature map are finally represented as a matrix [3,3] after the global pooling operation of a second size is performed. That is, global features of different degrees are obtained through different sizes.

Step 304, performing a non-local operation on an output obtained by performing a global average pooling operation of a large size.

Based on step 303, this step is intended to perform, by the above execution body, the non-local operation on the output obtained by performing the global average pooling operation of the large size. The global average pooling operation of the large size refers to a global average pooling operation of a size greater than 1×1.

The non-local operation is an operation different from a local operation. When a convolution operation of 3×3 in which stride=1 is performed, for any output position, only a neighborhood of a size of 3×3 can be seen by this convolution, that is, the output result of this convolution only needs to consider this 3×3 neighborhood. The size of the receptive field of this convolution is 3, which is referred to as the local operation. However, the non-local operation desires that for any output position, its output result can consider all positions (the entire input).

Here, stride is a concept commonly used in image processing, and a stride=the number of bytes occupied by each pixel (i.e., the number of bits per pixel/8)*Width. If the stride is not a multiple of 4, then the stride=stride+(4−Stride mod 4).

That is, by performing the non-local operation on the output obtained by performing the global average pooling operation of the size greater than 1×1, the obtained global feature can be further optimized based on the characteristics of the non-local operation.

Step 305, fusing the local feature and a global feature to obtain a fused feature.

Step 306, determining attentions of different channels using a channel self-attention mechanism, and weighting, according to the attentions of the channels, fused features outputted by the channels to obtain a weighted feature.

Based on step 305, this step is intended to determine, by the above execution body, the attentions of different channels in a neural network by introducing the channel self-attention mechanism, so as to weight the fused features outputted by the corresponding channels according to the attentions of the channels to obtain the weighted feature. That is, the fused features outputted by different channels can be better integrated by introducing the channel self-attention mechanism.

Step 307, converting the standard dynamic range image to a high dynamic range image based on the weighted feature.

On the basis of the embodiment shown in the flow 200, this embodiment provides a preferred global feature extraction approach through steps 303-304. That is, the at least two global average pooling operations of different sizes are performed through step 303, and the non-local operation is additionally performed on the output of the global average pooling operation of the large size, to further optimize the global feature. Moreover, the channel self-attention mechanism is introduced through steps 305-307, such that the fused features of outputted by different channels can be better weighted according to their impacts, thereby improving the quality of the finally converted high dynamic range image.

It should be understood that step 304 may exist independently from step 303, and it is not necessary to perform step 303, step 304 or the combination of step 303 and step 304 before performing steps 305-307, and steps 305-307 can be separately combined with steps of the flow 200 to form different embodiments. This embodiment only exists as a preferred embodiment including a plurality of preferred implementations at the same time.

For a deeper understanding, the present disclosure further provides a specific implementation in combination with a specific application scenario (see FIGS. 4-6).

In this embodiment, an SDR image of 8 bit YUV in a BT.709 color gamut is converted into an HDR image of 10 bit YUV in a BT.2020 color gamut, by means of an image format conversion model.

The structure of the image format conversion model is as shown in FIG. 4:

There is a to-be-converted SDR image on the left-most side of FIG. 4. It can be seen that there is a plurality of convolution modules for performing convolution operations, and a convolution operation of each convolution module is performed on a result obtained by performing a previous convolution operation of a previous convolution module, that is, the convolution models are superimposed and progressive. The result obtained by performing the convolution operation of each layer of convolution modules passes through the GL-GConv Resblock module (which may be referred to as a GL-G convolutional residual block for short, where the full name of GL-G is global-local gated, which is intended to emphasize that the convolutional residual block focuses on the extraction and processing on the global feature) constructed by the present disclosure. The GL-G convolutional residual block is improved on the basis of the standard convolutional residual block in a conventional residual network.

The local feature and the global feature can be obtained after the processing of the GL-G convolutional residual block, and are continuously converged by an up-sampling module to finally generate the HDR image.

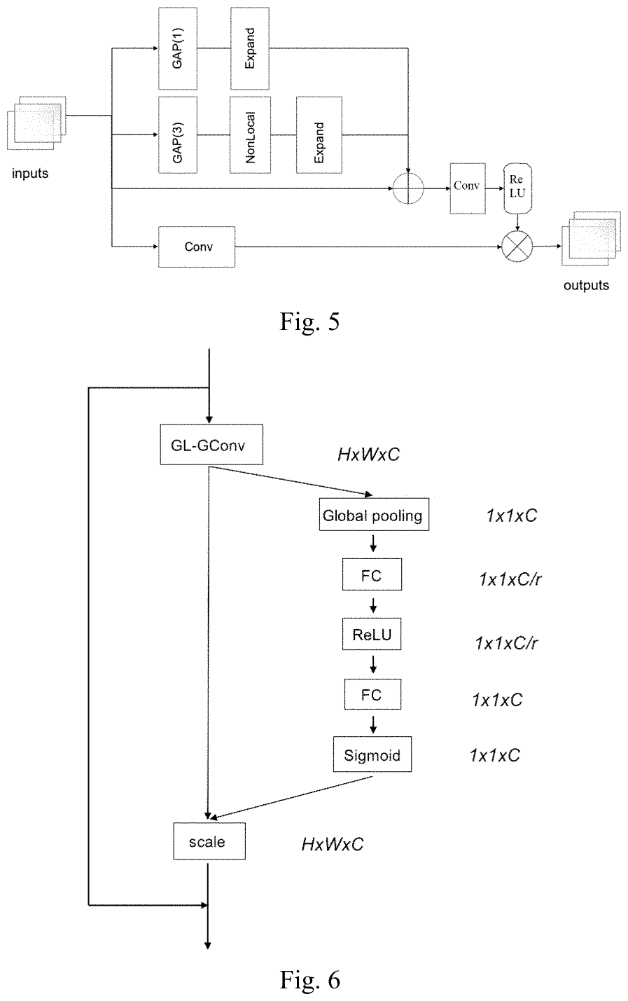

Specifically, for the internal structure of the GL-G convolutional residual block, reference may be made to the structural schematic diagram shown in FIG. 5. The core of the structure shown in FIG. 5 is a three-branch structure. That is, the inputted data respectively passes through the lowest convolution operation branch, and the global average pooling (GAP) operation branches of which the sizes are respectively 1 and 3. Here, the non-local operation is added after the global average pooling operation of which the size is 3, to further optimize the global feature. The subsequent Expand expands the concentrated global feature to the same size as the inputted data. Finally, the output is obtained after the convolution operation and the Relu activation function are performed.

In addition, FIG. 4 at the bottom shows the subsequent processing for the output of the GL-G convolutional residual block, that is, sequentially passing a GL-G convolution operation, a Relu activation function, a GL-G convolution operation, and a SEBlock module. The SEBlock module is a modular representation of the channel self-attention mechanism described above. Since each layer has the channel self-attention module, the module guides the fusion of data between different channels by passing the determined attention of the current channel to an upper layer.

For the specific structure of the SEBlock module, reference may be made to the schematic structural diagram shown in FIG. 6. Here, Global pooling refers to a global pooling operation, FC refers to a fully connected layer, and Relu and Sigmoid are respectively two different activation functions. Here, Relu is applicable to a shallow neural network, and Sigmoid is applicable to a deep neural network.

Meanwhile, the single-branch network-based model design shown in FIG. 4 further makes the whole model better in performance. After testing, the conversion of a 1080p image from SDR to HDR can be completed in 0.3 s, and the single-branch network can support the training of large patch size (the 1080P image can be directly inputted), which is more conducive to capturing and learning the global feature. However, the traditional multi-branch network is too complex and needs to slice the inputted image to input the image by slices (e.g., the 1080P image is sliced into 36 images of 160*160), resulting in an excessive time consumption.

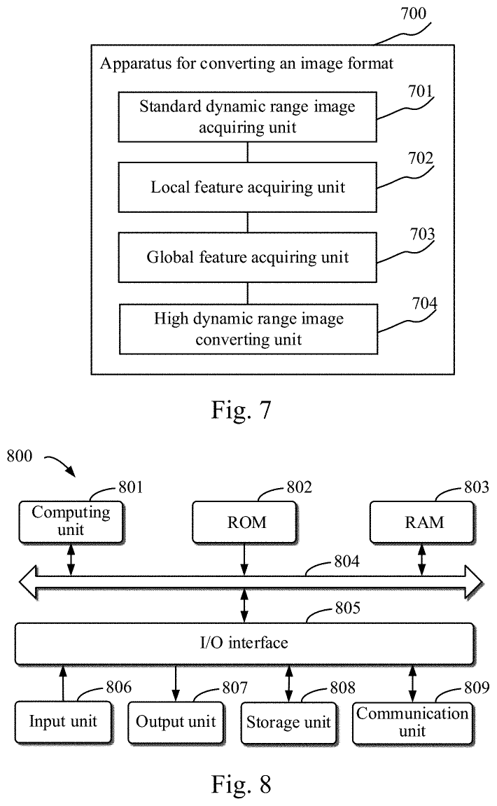

Further referring to FIG. 7, as an implementation of the method shown in the above drawings, the present disclosure provides an embodiment of an apparatus for converting an image format. The embodiment of the apparatus corresponds to the embodiment of the method shown in FIG. 2, and the apparatus may be applied in various electronic devices.

As shown in FIG. 7, the apparatus 700 for converting an image format in this embodiment may include: a standard dynamic range image acquiring unit 701, a local feature acquiring unit 702, a global feature acquiring unit 703 and a high dynamic range image converting unit 704. Here, the standard dynamic range image acquiring unit 701 is configured to acquire a to-be-converted standard dynamic range image. The local feature acquiring unit 702 is configured to perform a convolution operation on the standard dynamic range image to obtain a local feature. The global feature acquiring unit 703 is configured to perform a global average pooling operation on the standard dynamic range image to obtain a global feature. The high dynamic range image converting unit 704 is configured to convert the standard dynamic range image into a high dynamic range image according to the local feature and the global feature.

In this embodiment, for specific processes of the standard dynamic range image acquiring unit 701, the local feature acquiring unit 702, the global feature acquiring unit 703 and the high dynamic range image converting unit 704 in the apparatus 700 for converting an image format, and their technical effects, reference may be respectively made to relative descriptions of steps 201-204 in the corresponding embodiment of FIG. 2, and thus, the details will not be repeatedly described here.

In some alternative implementations of this embodiment, the global feature acquiring unit 703 may be further configured to:

perform at least two global average pooling operations of different sizes on the standard dynamic range image.

In some alternative implementations of this embodiment, the apparatus 700 for converting an image format may further include:

an optimized operation unit, configured to perform a non-local operation on an output obtained by performing a global average pooling operation of a large size, where the global average pooling operation of the large size refers to a global average pooling operation of a size greater than 1×1.

In some alternative implementations of this embodiment, the high dynamic range image converting unit 704 may be further configured to:

fuse the local feature and the global feature to obtain a fused feature;

determine attentions of different channels using a channel self-attention mechanism, and weight, according to the attentions of the channels, fused features outputted by the channels to obtain a weighted feature; and

convert the standard dynamic range image into the high dynamic range image based on the weighted feature.

In some alternative implementations of this embodiment, the local feature acquiring unit 702 may be further configured to:

extract the local feature of the standard dynamic range image using a convolutional layer of a preset image format conversion model, the convolutional layer including at least one convolution operation.

The global feature acquiring unit 703 may be further configured to:

extract the global feature of the standard dynamic range image using a global average pooling layer of the preset image format conversion model, the global average pooling layer including at least one global average pooling operation.

In some alternative implementations of this embodiment, when the standard dynamic range image is extracted from a standard dynamic range video, the apparatus 700 for converting an image format may further include:

a video generating unit, configured to generate a high dynamic range video according to consecutive high dynamic range images.

This embodiment exists as an apparatus embodiment corresponding to the above method embodiment.

Different from the schemas of converting a standard dynamic range image into a high dynamic range image in the existing technologies, the present disclosure provides an apparatus for converting an image format. According to the apparatus, the convolutional layer is used to extract the local feature of the standard dynamic range image, and the global average pooling layer is used to extract the global feature of the standard dynamic range image. Since the global feature of the standard dynamic range image is directly extracted through an independent global average pooling layer, a more accurate global feature can be extracted, and then the details required by the high dynamic range image can be obtained based on a more accurate supplement, thereby improving the quality of the converted high dynamic range image.

According to an embodiment of the present disclosure, the present disclosure further provides an electronic device, a readable storage medium and a computer program product.

FIG. 8 is a schematic block diagram of an exemplary electronic device 800 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may alternatively represent various forms of mobile apparatuses such as personal digital processer, a cellular telephone, a smart phone, a wearable device and other similar computing apparatuses. The electronic device may alternatively be a projection device capable of displaying images and a display device including a display. The parts shown herein, their connections and relationships, and their functions are only as examples, and not intended to limit implementations of the present disclosure as described and/or claimed herein.

As shown in FIG. 8, the device 800 includes a computing unit 801, which may perform various appropriate actions and processing, based on a computer program stored in a read-only memory (ROM) 802 or a computer program loaded from a storage unit 808 into a random access memory (RAM) 803. In the RAM 803, various programs and data required for the operation of the device 800 may also be stored. The computing unit 801, the ROM 802, and the RAM 803 are connected to each other through a bus 804. An input/output (I/O) interface 805 is also connected to the bus 804.

A plurality of parts in the device 800 are connected to the I/O interface 805, including: an input unit 806, for example, a keyboard and a mouse; an output unit 807, for example, various types of displays and speakers; the storage unit 808, for example, a disk and an optical disk; and a communication unit 809, for example, a network card, a modem, or a wireless communication transceiver. The communication unit 809 allows the device 800 to exchange information/data with other devices over a computer network such as the Internet and/or various telecommunication networks.

The computing unit 801 may be various general-purpose and/or dedicated processing components having processing and computing capabilities. Some examples of the computing unit 801 include, but are not limited to, central processing unit (CPU), graphics processing unit (GPU), various dedicated artificial intelligence (AI) computing chips, various computing units running machine learning model algorithms, digital signal processors (DSP), and any appropriate processors, controllers, microcontrollers, etc. The computing unit 801 performs the various methods and processes described above, such as a method for converting an image format. For example, in some embodiments, a method for converting an image format may be implemented as a computer software program, which is tangibly included in a machine readable medium, such as the storage unit 808. In some embodiments, part or all of the computer program may be loaded and/or installed on the device 800 via the ROM 802 and/or the communication unit 809. When the computer program is loaded into the RAM 803 and executed by the computing unit 801, one or more steps of a method for converting an image format described above may be performed. Alternatively, in other embodiments, the computing unit 801 may be configured to perform a method for converting an image format by any other appropriate means (for example, by means of firmware).

Various embodiments of the systems and technologies described above can be implemented in digital electronic circuit system, integrated circuit system, field programmable gate array (FPGA), application specific integrated circuit (ASIC), application special standard product (ASSP), system on chip (SOC), complex programmable logic device (CPLD), computer hardware, firmware, software, and/or combinations thereof. These various embodiments may include being implemented in one or more computer programs that may be executed and/or interpreted on a programmable system including at least one programmable processor, which may be a dedicated or general programmable processor that may receive data and instructions from a storage system, at least one input device, and at least one output device, and transmit data and instructions to the storage system, the at least one input device, and the at least one output device.

Program codes for implementing the method of the present disclosure may be written in any combination of one or more programming languages. These program codes may be provided to a processor or controller of a general purpose computer, special purpose computer or other programmable apparatus for data processing such that the program codes, when executed by the processor or controller, enables the functions/operations specified in the flowcharts and/or block diagrams being implemented. The program codes may execute entirely on the machine, partly on the machine, as a stand-alone software package partly on the machine and partly on the remote machine, or entirely on the remote machine or server.

In the context of the present disclosure, the machine readable medium may be a tangible medium that may contain or store programs for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, portable computer disk, hard disk, random access memory (RAM), read only memory (ROM), erasable programmable read only memory (EPROM or flash memory), optical fiber, portable compact disk read only memory (CD-ROM), optical storage device, magnetic storage device, or any suitable combination of the foregoing.

In order to provide interaction with the user, the systems and techniques described herein may be implemented on a computer having: a display device for displaying information to the user (e.g., a CRT (cathode ray tube) or LCD (liquid crystal display) monitor); a keyboard and a pointing device (e.g., mouse or trackball), through which the user can provide input to the computer. Other kinds of devices can also be used to provide interaction with users. For example, the feedback provided to the user may be any form of sensory feedback (e.g., visual feedback, auditory feedback, or tactile feedback); and the input from the user can be received in any form (including acoustic input, voice input or tactile input).

The systems and technologies described herein may be implemented in a computing system that includes a back-end component (e.g., as a data server), or a computing system that includes a middleware component (e.g., an application server), or a computing system that includes a front-end component (e.g., a user computer with a graphical user interface or a web browser through which the user can interact with an implementation of the systems and technologies described herein), or a computing system that includes any combination of such a back-end component, such a middleware component, or such a front-end component. The components of the system may be interconnected by digital data communication (e.g., a communication network) in any form or medium. Examples of the communication network include: a local area network (LAN), a wide area network (WAN), and the Internet.

The computer system may include a client and a server. The client and the server are generally remote from each other, and generally interact with each other through a communication network. The relationship between the client and the server is generated by virtue of computer programs that run on corresponding computers and have a client-server relationship with each other. The server may be a cloud server, which is also known as a cloud computing server or a cloud host, and is a host product in a cloud computing service system to solve the defects of difficult management and weak service extendibility existing in conventional physical hosts and virtual private servers (VPS).

Different from the schemas of converting a standard dynamic range image into a high dynamic range image in the existing technologies, in the technical solution provided in the embodiments of the present disclosure, a convolutional layer is used to extract a local feature of a standard dynamic range image, and a global average pooling layer is used to extract a global feature of the standard dynamic range image. Since the global feature of the standard dynamic range image is directly extracted through an independent global average pooling layer, a more accurate global feature can be extracted, and then the details required by a high dynamic range image can be obtained based on a more accurate supplement, thereby improving the quality of the converted high dynamic range image.

It should be understood that the various forms of processes shown above may be used to reorder, add, or delete steps. For example, the steps disclosed in the present disclosure may be executed in parallel, sequentially, or in different orders, as long as the desired results of the technical solutions mentioned in the present disclosure can be implemented. This is not limited herein.

The above specific implementations do not constitute any limitation to the scope of protection of the present disclosure. It should be understood by those skilled in the art that various modifications, combinations, sub-combinations, and replacements may be made according to the design requirements and other factors. Any modification, equivalent replacement, improvement, and the like made within the spirit and principle of the present disclosure should be encompassed within the scope of protection of the present disclosure.

What is claimed is:

1. A method for converting an image format, comprising:
acquiring a to-be-converted standard dynamic range image;
performing a convolution operation on the standard dynamic range image to obtain a local feature;
performing a global average pooling operation on the standard dynamic range image to obtain a global feature; and
converting the standard dynamic range image into a high dynamic range image according to the local feature and the global feature.

2. The method according to claim 1, wherein the performing a global average pooling operation on the standard dynamic range image comprises:
performing at least two global average pooling operations of different sizes on the standard dynamic range image.

3. The method according to claim 2, further comprising:
performing a non-local operation on an output obtained by performing a global average pooling operation of a large size, wherein the global average pooling operation of the large size refers to a global average pooling operation of a size greater than 1×1.

4. The method according to claim 1, wherein the converting the standard dynamic range image into a high dynamic range image according to the local feature and the global feature comprises:
fusing the local feature and the global feature to obtain a fused feature;
determining attentions of different channels using a channel self-attention mechanism, and weighting, according to the attentions of the channels, fused features outputted by the channels to obtain a weighted feature; and
converting the standard dynamic range image into the high dynamic range image based on the weighted feature.

5. The method according to claim 1, wherein the performing a convolution operation on the standard dynamic range image to obtain a local feature comprises:
extracting the local feature of the standard dynamic range image using a convolutional layer of a preset image format conversion model, the convolutional layer comprising at least one convolution operation, and
wherein the performing a global average pooling operation on the standard dynamic range image to obtain a global feature comprises:
extracting the global feature of the standard dynamic range image using a global average pooling layer of the preset image format conversion model, the global average pooling layer comprising at least one global average pooling operation.

6. The method according to claim 1, wherein, when the standard dynamic range image is extracted from a standard dynamic range video, the method further comprises:
generating a high dynamic range video according to consecutive high dynamic range images.

7. An electronic device, comprising:
at least one processor; and
a storage device, in communication with the at least one processor,
wherein the storage device stores instructions executable by the at least one processor, and the instructions, when executed by the at least one processor, cause the at least one processor to perform operations comprising:
acquiring a to-be-converted standard dynamic range image;
performing a convolution operation on the standard dynamic range image to obtain a local feature;
performing a global average pooling operation on the standard dynamic range image to obtain a global feature; and
converting the standard dynamic range image into a high dynamic range image according to the local feature and the global feature.

8. The electronic device according to claim 7, wherein the performing a global average pooling operation on the standard dynamic range image comprises:
performing at least two global average pooling operations of different sizes on the standard dynamic range image.

9. The electronic device according to claim 8, wherein the operations further comprise:
performing a non-local operation on an output obtained by performing a global average pooling operation of a large size, wherein the global average pooling operation of the large size refers to a global average pooling operation of a size greater than 1×1.

10. The electronic device according to claim 7, wherein the converting the standard dynamic range image into a high dynamic range image according to the local feature and the global feature comprises:
fusing the local feature and the global feature to obtain a fused feature;
determining attentions of different channels using a channel self-attention mechanism, and weighting, according to the attentions of the channels, fused features outputted by the channels to obtain a weighted feature; and
converting the standard dynamic range image into the high dynamic range image based on the weighted feature.

11. The electronic device according to claim 7, wherein the performing a convolution operation on the standard dynamic range image to obtain a local feature comprises:
extracting the local feature of the standard dynamic range image using a convolutional layer of a preset image format conversion model, the convolutional layer comprising at least one convolution operation, and
wherein the performing a global average pooling operation on the standard dynamic range image to obtain a global feature comprises:
extracting the global feature of the standard dynamic range image using a global average pooling layer of the preset image format conversion model, the global average pooling layer comprising at least one global average pooling operation.

12. The electronic device according to claim 7, wherein, when the standard dynamic range image is extracted from a standard dynamic range video, the operations further comprise:
generating a high dynamic range video according to consecutive high dynamic range images.

13. A non-transitory computer readable storage medium, storing computer instructions, wherein the computer instructions cause the computer to perform operations comprising:
acquiring a to-be-converted standard dynamic range image;
performing a convolution operation on the standard dynamic range image to obtain a local feature;
performing a global average pooling operation on the standard dynamic range image to obtain a global feature; and
converting the standard dynamic range image into a high dynamic range image according to the local feature and the global feature.

14. The non-transitory computer readable storage medium according to claim 13, wherein the performing a global average pooling operation on the standard dynamic range image comprises:
performing at least two global average pooling operations of different sizes on the standard dynamic range image.

15. The non-transitory computer readable storage medium according to claim 14, wherein the operations further comprise:
performing a non-local operation on an output obtained by performing a global average pooling operation of a large size, wherein the global average pooling operation of the large size refers to a global average pooling operation of a size greater than 1×1.

16. The non-transitory computer readable storage medium according to claim 13, wherein the converting the standard dynamic range image into a high dynamic range image according to the local feature and the global feature comprises:
fusing the local feature and the global feature to obtain a fused feature;
determining attentions of different channels using a channel self-attention mechanism, and weighting, according to the attentions of the channels, fused features outputted by the channels to obtain a weighted feature; and
converting the standard dynamic range image into the high dynamic range image based on the weighted feature.

17. The non-transitory computer readable storage medium according to claim 13, wherein the performing a convolution operation on the standard dynamic range image to obtain a local feature comprises:
extracting the local feature of the standard dynamic range image using a convolutional layer of a preset image format conversion model, the convolutional layer comprising at least one convolution operation, and
wherein the performing a global average pooling operation on the standard dynamic range image to obtain a global feature comprises:
extracting the global feature of the standard dynamic range image using a global average pooling layer of the preset image format conversion model, the global average pooling layer comprising at least one global average pooling operation.

18. The non-transitory computer readable storage medium according to claim 13, wherein, when the standard dynamic range image is extracted from a standard dynamic range video, the operations further comprise:
generating a high dynamic range video according to consecutive high dynamic range images.
